(19) United States
(12) Patent Application Publication
(10) Pub. No.: US 2014/0194158 A1
(43) Pub. Date: Jul. 10, 2014

(54) METHOD FOR INTELLIGENT ANTENNA CONFIGURATION SELECTION AND COMMUNICATION APPARATUS UTILIZING THE SAME

(71) Applicant: HTC Corporation, Taoyuan City (TW)

(72) Inventors: Win-Chyi GONG, Taoyuan City (TW); Haw-Wei SHU, Taoyuan City (TW); Hsing-Yu LUNG, Taoyuan City (TW); Yuan-Hao LAN, Taoyuan City (TW); Kuo-Hsing HUNG, Taoyuan City (TW); Chien-Jen HUANG, Taoyuan City (TW); Wei-Cheng SHIH, Taoyuan City (TW)

(73) Assignee: HTC Corporation, Taoyuan City (TW)

(21) Appl. No.: 14/148,413

(22) Filed: Jan. 6, 2014

Related U.S. Application Data
(60) Provisional application No. 61/749,153, filed on Jan. 4, 2013.

(51) Int. Cl. H04W 88/06

(52) U.S. Cl. CPC H04W 88/06
USPC 455/553.1

(57) ABSTRACT

A method for intelligent antenna configuration selection of a communication apparatus including an antenna module including a plurality of antennas and a plurality of radio modules sharing the antenna module includes individually determining a preferred antenna configuration of the antenna module by each radio module; determining an optimum antenna configuration according to the preferred antenna configurations; and controlling a configuration of the antennas based on the optimum antenna configuration. The optimum antenna configuration is determined for a radio module having a highest priority among the radio modules to have an optimum radio communication performance.

### CROSS REFERENCE TO RELATED APPLICATIONS

This application claims the benefit of U.S. Provisional Application No. 61/749,153 filed Jan. 4, 2013 and entitled “Multi-Controller Decision Based Dynamic Antenna Solution”, the entire contents of which are hereby incorporated by reference.

### BACKGROUND OF THE INVENTION

1. Field of the Invention

The invention relates to methods for intelligent antenna configuration selection.

2. Description of the Related Art

Wireless communication systems are widely deployed to provide various types of communication content such as voice communication and data communication. Typical wireless communication systems may be multiple-access systems capable of supporting communication with multiple users by sharing available system resources (e.g., bandwidth, transmit power, etc.). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP2, 3GPP long-term evolution (LTE), LTE Advanced (LTE-A), etc.

Nowadays, mobile devices may simultaneously support communication using multiple radio access technologies (RATS). Different radio access technologies may be used to expand the scope of services offered by the communication system such as by expanding the geographic region in which the device may operate, as a mobile device moves through different regions supporting different radio access technologies. Furthermore, different radio access technologies may be used to simultaneously allow a user to engage in a variety of different forms of wireless communication activities.

In order to improve the communication performance for the mobile devices supporting multiple RATs, some novel methods for intelligent antenna configuration selection are required.

### BRIEF SUMMARY OF THE INVENTION

Communication apparatuses and methods for intelligent antenna configuration selection are provided. An exemplary embodiment of a communication apparatus comprises an antenna module, a switching circuit, a first radio module, a second radio module and an arbitration controller. The antenna module comprises a plurality of antennas. The switching circuit is coupled to the antenna module for controlling a configuration of the antennas according to an antenna configuration indication signal. The first radio module comprises a first controller for determining a first preferred antenna configuration of the antenna module. The second radio module comprises a second controller for determining a second preferred antenna configuration of the antenna module. The arbitration controller is coupled to the first radio module and the second radio module, obtaining information regarding the first preferred antenna configuration and the second preferred antenna configuration respectively from the first radio module and the second radio module, determines an optimum antenna configuration according to the first preferred antenna configuration and the second preferred antenna configuration based on a priority of the first radio module and a priority of the second radio module and generates the antenna configuration indication signal based on the optimum antenna configuration.

Another exemplary embodiment of a communication apparatus comprises an antenna module, a switching circuit, a first radio module, a second radio module and an arbitration controller. The antenna module comprises a plurality of antennas. The switching circuit is coupled to the antenna module for controlling a configuration of the antennas according to an antenna configuration indication signal. The first radio module provides communication services in compliance with a first radio access technology (RAT). The second radio module provides communication services in compliance with a second RAT. The first radio module and the second radio module share the antenna module. The arbitration controller is coupled to the first radio module and the second radio module, determines an optimum antenna configuration based on a predefined decision matrix and generates the antenna configuration indication signal based on the optimum antenna configuration.

Another exemplary embodiment of a method for intelligent antenna configuration selection of a communication apparatus comprising an antenna module comprising a plurality of antennas and a plurality of radio modules sharing the antenna module comprises: individually determining a preferred antenna configuration of the antenna module by each radio module; determining an optimum antenna configuration according to the preferred antenna configurations; and controlling a configuration of the antennas based on the optimum antenna configuration, wherein the optimum antenna configuration is determined for a radio module having a highest priority among the radio modules to have an optimum radio communication performance.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a schematic block diagram of a communication apparatus according to an embodiment of the invention;

FIG. 2 is a schematic block diagram of a communication apparatus according to another embodiment of the invention;

FIG. 3 is a schematic block diagram of a radio module according to an embodiment of the invention;

FIG. 4 shows an exemplary decision matrix according to an embodiment of the invention;

FIG. 5 shows another exemplary decision matrix according to another embodiment of the invention;

FIG. 6 shows yet another exemplary decision matrix according to another embodiment of the invention;

FIG. 7 shows an exemplary block diagram of a controller according to an embodiment of the invention;

FIG. 8 shows an exemplary schematic diagram of antenna configuration flow according to an embodiment of the invention;

FIG. 9 shows an exemplary schematic diagram of antenna configuration flow according to another embodiment of the invention; and

FIG. 10 shows a flow chart of a method for intelligent antenna configuration selection according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

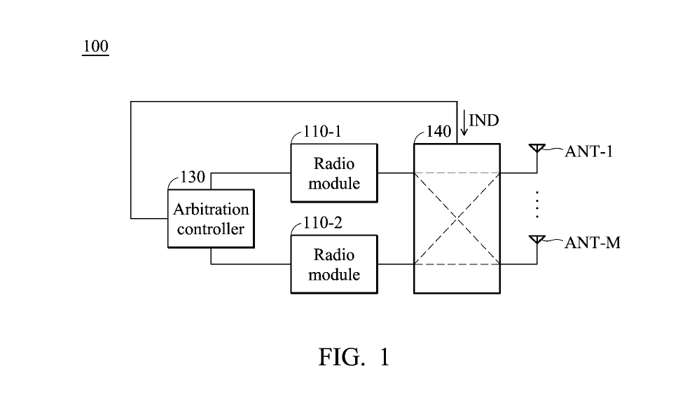

FIG. 1 is a schematic block diagram of a communication apparatus according to an embodiment of the invention. The communication apparatus may at least comprise radio modules 110-1 and 110-2, an arbitration controller 130, a switching circuit 140 and an antenna module comprising a plurality of antennas ANT-1˜ANT-M. The radio modules 110-1 and 110-2 may provide communication services in compliance with the same or different radio access technologies (RATs) and may share the antennas of the antenna module. The RAT may be LTE-FDD, LTE-TDD, WCDMA, TD-SCDMA, CDMA1×RTT, CDMA 1×EVDO, GSM, GPRS, EGPRS, or others.

The arbitration controller 130 is coupled to the radio modules 110-1 and 110-2 and may perform arbitration between the radio modules 110-1 and 110-2. For example, in one embodiment of the invention, since the radio modules 110-1 and 110-2 share the antennas of the antenna module, the arbitration controller 130 may arbitrate the right of using or configuring the antennas. The switching circuit 140 is coupled to the antenna module for controlling a configuration of the antennas according to an antenna configuration indication signal IND received from the arbitration controller 130.

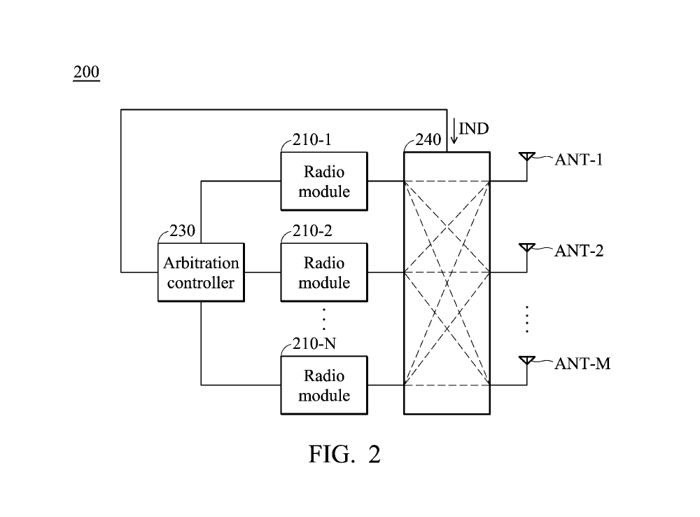

FIG. 2 is a schematic block diagram of a communication apparatus according to another embodiment of the invention. The communication apparatus may at least comprise radio modules 210-1, 210-2 . . . 210-N, an arbitration controller 230, a switching circuit 240 and an antenna module comprising a plurality of antennas ANT-1˜ANT-M. The radio modules 210-1, 210-2 . . . 210-N may provide communication services in compliance with the same or different radio access technologies (RATs) and may share the antennas of the antenna module. The RAT may be LTE-FDD, LTE-TDD, WCDMA, TD-SCDMA, CDMA1×RTT, CDMA 1×EVDO, GSM, GPRS, EGPRS, or others.

The arbitration controller 230 is coupled to the radio modules 210-1, 210-2 . . . 210-N and may perform arbitration between the radio modules 210-1, 210-2 . . . 210-N. For example, in one embodiment of the invention, since the radio modules 210-1, 210-2 . . . 210-N share the antennas of the antenna module, the arbitration controller 230 may arbitrate the right of using or configuring the antennas. The switching circuit 240 is coupled to the antenna module for controlling a configuration of the antennas according to an antenna configuration indication signal IND received from the arbitration controller 230.

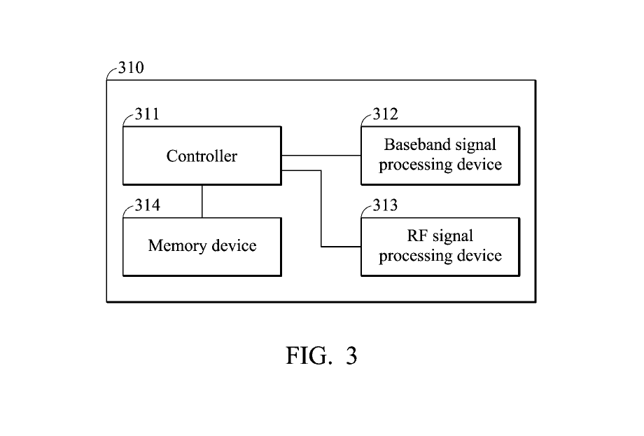

FIG. 3 is a schematic block diagram of a radio module according to an embodiment of the invention. The radio module 310 may at least comprise a controller 311, a baseband signal processing device 312, a RF signal processing device 313 and a memory device 314. The baseband signal processing device 312 may comprise a plurality of hardware devices to perform baseband signal processing, such as Analog to Digital Conversion (ADC)/Digital to Analog Conversion (DAC), gain adjusting, modulation/demodulation, encoding/decoding, and so on. The RF signal processing device 313 may receive RF wireless signals, convert the received RF wireless signals to baseband signals, which are processed by the baseband signal processing device 312, or receive baseband signals from the baseband signal processing device 312 and convert the received baseband signals to RF wireless signals, which are later transmitted. The RF signal processing device 313 may also comprise a plurality of hardware devices to perform RF signal processing. The controller 311 may control the operation of the baseband signal processing device 312, the RF signal processing device 313 and the memory device 314. The memory device 314 may store system and/or user data.

Note that radio module 310 may be one or more of the radio modules 110-1 and 110-2 as shown in FIG. 1, and/or one or more of the radio modules 210-1˜210-N as shown in FIG. 2. In addition, the radio module 310 may be designed for a specific RAT, a specific communication service (such as the circuit switch service or packet switch service), or others, and may be implemented as a modem, a chipset, a SoC, or others. Therefore, the controller 311 may correspond to a RAT, a communication service, a modem, a SoC, a chipset, or others. In addition, in order to clarify the concept of the invention, FIG. 1˜FIG. 3 present simplified block diagrams, in which only the elements relevant to the invention are shown. However, note that the invention should not be limited what are shown in the FIG. 1˜FIG. 3.

Considering the scenario when a single communication apparatus can concurrently support dual radios as shown in FIG. 1 or multi-radio as shown in FIG. 2, methods for intelligent antenna configuration selection are discussed in the following paragraphs. Note that those who are skilled in this technology can still make various alterations and modifications without departing from the scope and spirit of this invention to apply the proposed methods in the scenario when the communication apparatus only supports single radio, and the invention should not be limited thereto.

According to an embodiment of the invention, the controller (e.g. the controller 311) in each radio module may individually determine a preferred antenna configuration of the antenna module. The arbitration controller (e.g. the arbitration controller 130, 230) may receive information regarding the preferred antenna configuration from each radio module, determine an optimum antenna configuration according to the preferred antenna configurations, and generate the antenna configuration indication signal IND based on the optimum antenna configuration. In this manner, the switching circuit (e.g. switching circuit 140, 240) may control the configuration of the antennas according to the antenna configuration indication signal IND.

In a first aspect of the invention, the arbitration controller may determine the optimum antenna configuration based on a priority of each radio module. For example, according to an embodiment of the invention, the arbitration controller may select one of the preferred antenna configurations of the radio modules as the optimum antenna configuration based on a priority of each radio module. In addition, according to another embodiment of the invention, the arbitration controller itself may also determine a preferred antenna configuration, and select one from all the preferred antenna configurations as the optimum antenna configuration based on a priority of each radio module.

For example, when a radio module has a highest priority among all the radio modules, the arbitration controller may select one from the preferred antenna configurations for the radio module having highest priority to have an optimum radio communication performance. Here, the optimum radio communication performance may be flexibly designed based on different system requirements. For example, the optimum radio communication performance may be an optimum voice communication quality, an optimum data transmission rate, an optimum received signal power, an optimum transmission power consumption, or others.

According to an embodiment of the invention, the priority of a radio module may be determined based on one or a combination of a plurality of factors comprising at least a frequency band currently used by the corresponding radio module, a state in which the corresponding radio module currently operates, a radio access technology of the corresponding radio module, a communication service currently provided by the corresponding radio module, the radio condition of the corresponding radio module, the temperature of the corresponding radio module, or others. Here, the state that the radio module operates in may be the state officially defined in the corresponding communication standard, such as the idle/standby state and the connected state in 2G/3G/4G RAT, or any states defined by the manufacturers. In addition, the radio condition may be any possible condition that the radio module and/or the communication apparatus could meet, such as excellent or poor signal quality, out of service, network crowded, or one or a combination of the plurality of factors as discussed above, or others, and may be flexibly defined by the manufacturers.

In a second aspect of the invention, the arbitration controller may determine the optimum antenna configuration based on a predefined decision matrix. According to an embodiment of the invention, the predefined decision matrix may be established based on relationships between a plurality of antenna configurations and one or a combination of a plurality of factors comprising at least a priority of the radio modules, a frequency band used by the radio modules, a state in which the radio modules operate, the RAT of the radio modules, a communication service provided by the corresponding radio module, the radio condition of the corresponding radio module, the temperature of the corresponding radio module, or others.

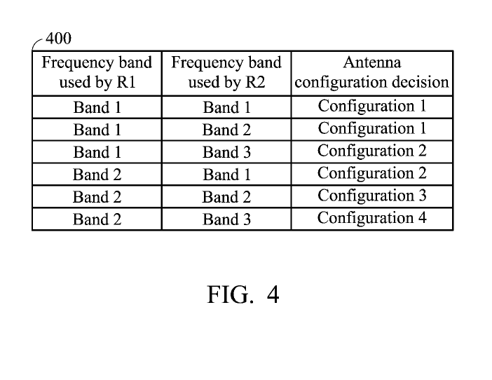

FIG. 4 shows an exemplary decision matrix according to an embodiment of the invention. In the embodiment, the decision matrix 400 is established based on relationships between four antenna configurations, two frequency bands used by the radio module R1 and three frequency bands used by the radio module R2. According to an embodiment of the invention, the antenna configuration may describe the settings of one or more antenna-related parameters of the antennas in the antenna module, switching of the antennas, or others. For example, the antenna configuration may describe the antenna matching parameters of the antennas, the switching (that is, the connecting paths) of the antennas, or others. According to an embodiment of the invention, the antenna configuration may also describe some related actions, such as no change (that is, keeping the previous configuration), configuring to a default setting, dynamic antenna for measurement before one trial, dynamic antenna after one trail failure, blind dynamic antenna, measurement dynamic antenna, or others.

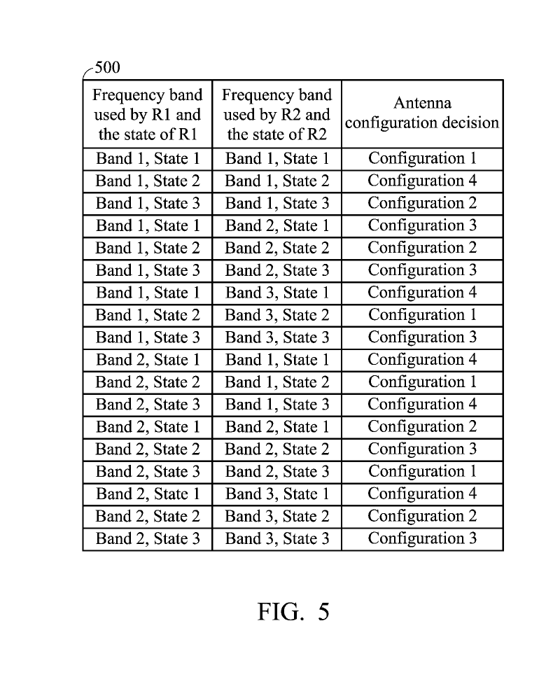

FIG. 5 shows another exemplary decision matrix according to another embodiment of the invention. In the embodiment, the decision matrix 500 is established based on relationships between four antenna configurations, two frequency bands used by the radio module R1, three frequency bands used by the radio module R2 and three states of radio modules R1 and R2. As discussed above, the state that the radio module operates in may be the state officially defined in the corresponding communication standard, such as the idle/standby state and the connected states in 2G/3G/4G RAT, or any states defined by the manufacturers.

According to another embodiment in the second aspect of the invention, the controller (e.g. the controller 311) in each radio module may individually determine a preferred antenna configuration of the antenna module, and the arbitration controller may select one from the preferred antenna configurations as the optimum antenna configuration based on a predefined decision matrix. In addition, according to another embodiment of the invention, the arbitration controller itself may also determine a preferred antenna configuration, and select one from all the preferred antenna configurations as the optimum antenna configuration based on a predefined decision matrix.

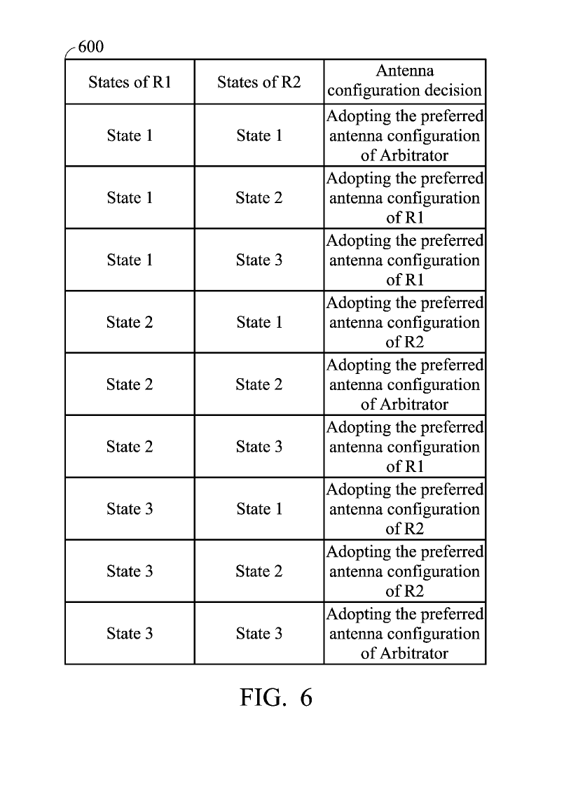

FIG. 6 shows yet another exemplary decision matrix according to another embodiment of the invention. In the embodiment, the decision matrix indicates the preferred antenna configuration determined by which radio module or the arbitration controller should be adopted under a plurality of different conditions of the communication apparatus. As shown in FIG. 6, the decision matrix 600 is established based on relationships between the preferred antenna configurations determined by the radio modules R1 and R2 and the arbitration controller Arbitrator and three states of radio modules R1 and R2.

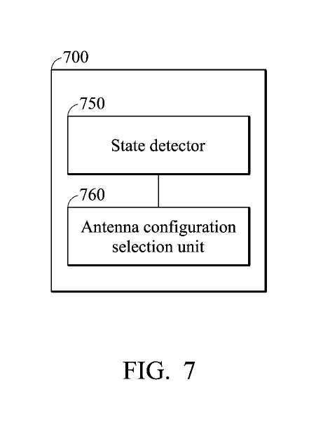

FIG. 7 shows an exemplary block diagram of a controller according to an embodiment of the invention. The controller 700 may be the arbitration controller or the controller in a radio module, and may comprise a state detector 750 and an antenna configuration selection unit 760. The state detector 750 may detect a state which the corresponding radio module currently operates in, and may further forward information regarding the state which the corresponding radio module currently operates in (hereinafter called the state information) to the antenna configuration selection unit 760. Note that when the controller 700 is the arbitration controller, the state detector 750 may collects state information from the multiple radio modules, and forward the state information to the antenna configuration selection unit 760. The antenna configuration selection unit 760 may select a preferred antenna configuration based on the state information, the priority and the predefined decision matrix as discussed above, and/or any other factors.

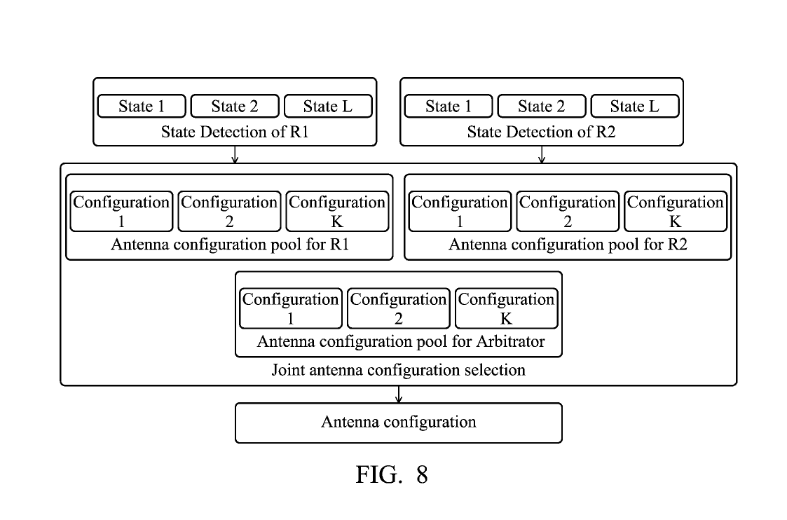

FIG. 8 shows an exemplary schematic diagram of antenna configuration flow according to an embodiment of the invention. In the embodiment, the state detection is first individually preformed at the radio modules R1 and R2 and the state information is passed to the antenna configuration selection unit of the radio modules R1 and R2 and the arbitration controller Arbitrator for individually selecting a preferred antenna configuration from the corresponding antenna configuration pool. In the embodiment, the antenna configuration pool for a radio module may be a specific pool, and the antenna configuration pool for the Arbitrator may be a common pool.

Next, the Arbitrator may execute a joint antenna configuration selection based on the preferred antenna configurations, the priorities of the radio modules, and/or the predefined decision matrix as discussed above, so as to determine an optimum antenna configuration. Finally, the antennas are configured based on the optimum antenna configuration.

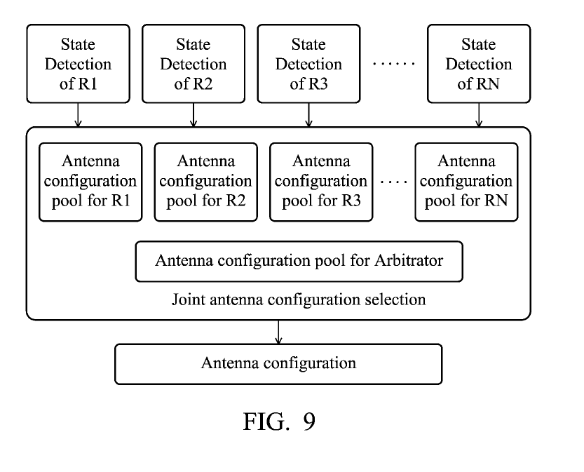

FIG. 9 shows an exemplary schematic diagram of antenna configuration flow according to an embodiment of the invention. Different from FIG. 8, in the embodiment, there are more than two radio modules (for example, the communication apparatus having more than two radio modules as shown in FIG. 2) joins the antenna configuration selection. In the embodiment, the state detection is first individually preformed at the radio modules R1˜RN and the state information is passed to the antenna configuration selection unit of the radio modules R1˜RN and the arbitration controller Arbitrator for individually selecting a preferred antenna configuration from the corresponding antenna configuration pool. In the embodiment, the antenna configuration pool for a radio module may be a specific pool, and the antenna configuration pool for the Arbitrator may be a common pool.

Next, the Arbitrator may execute a joint antenna configuration selection based on the preferred antenna configurations, the priorities of the radio modules, and/or the predefined decision matrix as discussed above, so as to determine an optimum antenna configuration. Finally, the antennas are configured based on the optimum antenna configuration.

Note that in the embodiments of the invention, the joint antenna configuration selection is not necessary performed by the arbitration controller. For example, in some embodiments of the invention, the joint antenna configuration selection may be performed by any controller in the radio modules. For another example, the arbitration controller may be integrated in or directly implemented by the controller of one radio module. When the arbitration controller is integrated in or directly implemented by the controller of one radio module, it may be a master and slave structure (where the controller comprising the arbitration ability may be a master controller and the remaining controller(s) may be the slave controller(s)), and the slave controller(s) does not perform the joint antenna configuration selection.

Note further that in some embodiments of the invention, the antenna configuration selection may also be handled by a single controller of a single radio communication apparatus, where the controller may correspond to a RAT, a communication service, a modem, a SoC, a chipset, or others as discussed above.

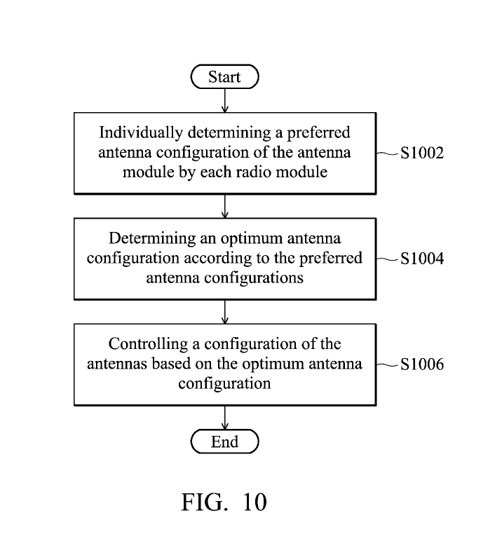

FIG. 10 shows a flow chart of a method for intelligent antenna configuration selection of a communication apparatus comprising an antenna module comprising a plurality of antennas and a plurality of radio modules sharing the antenna module according to an embodiment of the invention. First of all, a preferred antenna configuration of the antenna module may be individually determined by each radio module (Step S1002). Next, an optimum antenna configuration is determined according to the preferred antenna configurations (Step S1004). Finally, a configuration of the antennas is controlled based on the optimum antenna configuration (Step S1006).

In some embodiments of the invention, the optimum antenna configuration is determined for a radio module having a highest priority among the radio modules to have an optimum radio communication performance. The optimum antenna configuration may be determined based on the priorities of the radio modules and/or the predefined decision matrix as discussed above. The predefined decision matrix may be established based on relationships between a plurality of antenna configurations (or, preferred antenna configuration individually determined by the radio modules and the arbitration controller) and one or a combination of a plurality of factors comprising at least a priority of the radio modules, a frequency band used by the radio modules, a state in which the radio modules operate, the RAT of the radio modules, and a communication service provided by the radio modules, or other. The predefined decision matrix may also be established based on relationships between the preferred antenna configuration determined by which radio module or arbitration controller is adopted under a plurality of different radio conditions of the communication apparatus. The radio condition may be any possible condition that the radio module and/or the communication apparatus could meet, and may be flexibly defined by the manufacturers.

The above-described embodiments of the present invention can be implemented in any of numerous ways. For example, the embodiments may be implemented using hardware, software or a combination thereof. It should be appreciated that any component or collection of components that perform the functions described above can be generically considered as one or more processors that control the above discussed function. The one or more processors can be implemented in numerous ways, such as with dedicated hardware, or with general purpose hardware that is programmed using microcode or software to perform the functions recited above.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A communication apparatus, comprising:
an antenna module, comprising a plurality of antennas;
a switching circuit, coupled to the antenna module for controlling a configuration of the antennas according to an antenna configuration indication signal;
a first radio module, comprising a first controller for determining a first preferred antenna configuration of the antenna module;
a second radio module, comprising a second controller for determining a second preferred antenna configuration of the antenna module; and
an arbitration controller, coupled to the first radio module and the second radio module, obtaining information regarding the first preferred antenna configuration and the second preferred antenna configuration respectively from the first radio module and the second radio module, determining an optimum antenna configuration according to the first preferred antenna configuration and the second preferred antenna configuration based on a priority of the first radio module and a priority of the second radio module and generating the antenna configuration indication signal based on the optimum antenna configuration.

2. The communication apparatus as claimed in claim 1, wherein the arbitration controller further determines a third preferred antenna configuration and selects one of the first preferred antenna configuration, the second preferred antenna configuration and the third preferred antenna configuration as the optimum antenna configuration based on the priority of the first radio module and the priority of the second radio module.

3. The communication apparatus as claimed in claim 2, wherein when the priority of the first radio module is higher than the priority of the second radio module, the arbitration controller selects one of the first preferred antenna configuration, the second preferred antenna configuration and the third preferred antenna configuration as the optimum antenna configuration for the first radio module to have an optimum radio communication performance.

4. The communication apparatus as claimed in claim 1, wherein the priority of first radio module and the priority of the second radio module are determined based on one or a combination of a plurality of factors comprising at least a frequency band currently used by the corresponding radio module, a state in which the corresponding radio module currently operates, a radio access technology of the corresponding radio module, and a communication service currently provided by the corresponding radio module.

5. The communication apparatus as claimed in claim 1, wherein the configuration of the antennas comprises settings of one or more antenna-related parameters of the antennas and switching of the antennas.

6. A communication apparatus, comprising:
an antenna module, comprising a plurality of antennas;
a switching circuit, coupled to the antenna module for controlling a configuration of the antennas according to an antenna configuration indication signal;
a first radio module, providing communication services in compliance with a first radio access technology (RAT);
a second radio module, providing communication services in compliance with a second RAT, wherein the first radio module and the second radio module share the antenna module; and
an arbitration controller, coupled to the first radio module and the second radio module, determining an optimum antenna configuration based on a predefined decision matrix and generating the antenna configuration indication signal based on the optimum antenna configuration.

7. The communication apparatus as claimed in claim 6, wherein the predefined decision matrix is established based on relationships between a plurality of antenna configurations and one or a combination of a plurality of factors comprising at least a priority of the first/second radio module, a frequency band used by the first/second radio module, a state in which the first/second radio module operates, the RAT of the first/second radio module, and a communication service provided by the first/second radio module.

8. The communication apparatus as claimed in claim 6, wherein the first radio module and the second radio module individually determine a preferred antenna configuration of the antenna module, and the arbitration controller selects one of the preferred antenna configurations determined by the first radio module and the second radio module as the optimum antenna configuration based on the predefined decision matrix.

9. The communication apparatus as claimed in claim 8, wherein the arbitration controller further determines a preferred antenna configuration of the antenna module, and selects one of the preferred antenna configurations determined by the first radio module, the second radio module and the arbitration controller itself as the optimum antenna configuration based on the predefined decision matrix.

10. The communication apparatus as claimed in claim 6, wherein the configuration of the antennas comprises settings of one or more antenna-related parameters of the antennas and switching of the antennas.

11. A method for intelligent antenna configuration selection of a communication apparatus comprising an antenna module comprising a plurality of antennas and a plurality of radio modules sharing the antenna module, comprising:
individually determining a preferred antenna configuration of the antenna module by each radio module;
determining an optimum antenna configuration according to the preferred antenna configurations; and
controlling a configuration of the antennas based on the optimum antenna configuration,
wherein the optimum antenna configuration is determined for a radio module having a highest priority among the radio modules to have an optimum radio communication performance.

12. The method as claimed in claim 11, wherein a priority of each radio module is determined based on one or a combination of a plurality of factors comprising at least a frequency band currently used by the corresponding radio module, a state in which the corresponding radio module currently operates, a radio access technology of the corresponding radio module, and a communication service currently provided by the corresponding radio module.

13. The method as claimed in claim 11, wherein the optimum antenna configuration is determined based on a predefined decision matrix, and wherein the predefined decision matrix is established based on relationships between a plurality of antenna configurations and one or a combination of a plurality of factors comprising at least a priority of the radio modules, a frequency band used by the radio modules, a state in which the radio modules operate, the RAT of the radio modules, and a communication service provided by the radio modules.

14. The method as claimed in claim 11, wherein the optimum antenna configuration is determined based on a predefined decision matrix, and wherein the predefined decision matrix indicates the preferred antenna configuration determined by which radio module is adopted under a plurality of different radio conditions of the communication apparatus.

15. The method as claimed in claim 11, wherein the configuration of the antennas comprises settings of one or more antenna-related parameters of the antennas and switching of the antennas.
